(19) United States
(12) Patent Application Publication
(10) Pub. No.: US 2009/0108845 A1
(43) Pub. Date: Apr. 30, 2009

(54) SYSTEM FOR SEISMIC DETECTION AND ANALYSIS

(76) Inventor: Michael Kaminski, Thompson, ND (US)

Correspondence Address: ADVANTIA LAW GROUP, 9035 SOUTH 1300 EAST, SUITE 200, SANDY, UT, 84094, US

(21) Appl. No.: 12/257,297

(22) Filed: Oct. 23, 2008

Related U.S. Application Data
(60) Provisional application No. 60/983,365, filed on Oct. 29, 2007.

(51) Int. Cl. G01V 3/38

(52) U.S. Cl. 324/337

(57) ABSTRACT

A system and method for detecting and processing electromagnetic signals from seismic activity, wherein the system and method includes an antenna configured to receive electromagnetic signals. The antenna includes a coiled electrical conduit having a length equal to about the diameter of the Earth. The antenna also includes a plurality of center taps disposed about critical resonant frequencies of a compound or element. The system and method also includes a signal processing module in communication with the antenna and configured to receive and process electromagnetic signals. The system and method further includes a impulse generation device configured to generate seismic activity. Furthermore, the system and method includes a control module in communication with the signal processing module and the impulse generation module and configured to provide instruction signals to each.

### CROSS-REFERENCE TO RELATED APPLICATIONS

This invention claims priority, under 35 U.S.C. §120, to the U.S. Provisional Patent Application No. 60/983,365 to Kaminski filed on Oct. 29, 2007, which is incorporated by reference herein.

### BACKGROUND OF THE INVENTION

1. Field of the Invention

The present invention relates to systems for subterranean investigations and detections, specifically to systems for seismic, electro-seismic, and/or compression subterranean investigations and detections.

2. Description of the Related Art

One of the greatest innovations in the history of petroleum exploration is the use of computers to compile and assemble geologic and seismic data. Although the seismograph was originally developed to measure earthquakes, it was discovered that much the same sort of vibrations and seismic waves could be produced artificially and used to map underground geologic formations using this data.

Seismic surveys use vibration (induced by an explosive charge or sound generating equipment) to provide a picture of subterranean rock formations at depth, often as deep as 30,000 feet below ground level (BGL). This is accomplished by generating sound waves downward into the earth's crust which reflect off various boundaries between different rock strata. On land, the sound waves are generated by small explosive charges embedded in the ground, or by vibrator trucks, sometimes referred to as “thumpers” which shake the ground with hydraulically driven metal pads. The human ear can barely hear the thump, but the frequency generated penetrates the earth's crust. The echoes are detected by electronic devices called geophones which receive the reflected sound waves and the data are recorded on magnetic tape which is printed to produce a two-dimensional (2D) graphic illustrating the subsurface geology. Three-dimensional (3-D) seismic imaging utilizes seismic field data to generate a three dimensional “picture” of underground formations and geologic features. A geophysicist may, with limited success, use traditional 2-D modeling and examination of geologic features to determine if there is a probability of the presence of natural gas. Once these basic techniques are used, 3-D seismic imaging may be used only in those areas that have a high probability of containing reservoirs. Some improvements have been made in the field. Examples of references related to the present invention are described below, and the supported teachings of each reference are incorporated by reference herein:

U.S. Pat. No. 6,900,639, issued to Ellingsrud et al., which discloses a system for investigating subterranean strata. An electromagnetic field is applied using a dipole antenna transmitter and this is detected using a dipole antenna receiver. Phase information is extracted from a refracted wave response and used to identify the presence and/or nature of a subterranean reservoir.

U.S. Pat. No. 5,486,764, issued to Thompson et al., which discloses a method and apparatus for estimating the earth's resistance (conductivity) as a function of depth using electroseismic prospecting (ESP) or inverse ESP techniques. Resistance is determined by the frequency-dependent attenuation of reflected EM signals which are produced by application of seismic signals to the earth. A seismic wave is generated by conventional means into the earth, and EM waves are generated back to the surface by different reflectors at different depth levels. This propagation attenuates the high frequencies preferentially. EM waves generated at lower depths are further attenuated relative to those waves generated at more shallow depths. The method and apparatus determines the difference in spectral content between the reflected signals from different horizons based on their relative attenuation and uses this difference as a direct measure of the conductivity between the horizons. Inverse ESP effects can also be used to generate EM waves into the earth and use reflected seismic waves to determine resistance as a function of depth.

U.S. Pat. No. 4,904,942, issued to Thompson, which discloses a method of electroseismic prospecting is disclosed for detecting either the presence of two immiscible fluids present in a porous subterranean formation or the presence of a high-permeability rock formation including a substantially aqueous phase therein. A seismic impact produces an acoustical wave front that results in an enhanced electromagnetic signal when it encounters either type of the above-described formations. This resulting enhanced electromagnetic signal is detectable as an indication of a likely hydrocarbon deposit, thereby giving additional data information with conventional seismic data to the geophysical prospector.

U.S. Pat. No. 7,042,801, issued to Berg, which discloses methods for employing seismic waves having infrasonic frequencies in the range of about 0.1 20 Hz for generating electromagnetic waves of similar infrasonic frequency in hydrocarbon bearing subterranean formations located at depths up to about 5000 meters, said electromagnetic waves having sufficient voltage amplitudes for detection at the earth's surface. Also disclosed are seismic sources capable of generating infrasonic seismic waves of sufficient amplitude for generating electromagnetic waves in hydrocarbon bearing formations at depths up to 5000 meters, said electromagnetic waves having voltage amplitudes sufficient for detection at the earth's surface.

U.S. Pat. No. 6,477,113, issued to Hornbostel et al., discloses a method for seismic exploration using conversions between electromagnetic and seismic energy, with particular attention to the electromagnetic source waveform used. According to the invention, source waveforms are correlated with reference waveforms selected to minimize correlation side lobes. Line power at 60 Hz may be used to provide a waveform element which may be sequenced by a binary code to generate an extended source waveform segment with minimal correlation side lobes. Preferred binary codes include Golay complementary pairs and maximal length shift-register sequences.

U.S. Pat. No. 5,841,280, issued to Yu et al., discloses A method for estimating porosity of an earth formation from measurements of acoustic energy traversing the earth formation and from measurements of seismoelectric voltages generated in the formation in response to the acoustic energy. The method includes the steps of measuring the acoustic energy traversing the earth formation and measuring said seismoelectric voltages generated in response to the acoustic energy traversing the formation. A seismoelectric signal is synthesized from the measurements of the acoustic energy using an initial value of the porosity. A difference is determined between the synthesized seismoelectric voltages and the measured seismoelectric voltages. The initial value of porosity is adjusted, and the steps of synthesizing the seismoelectric voltages from the acoustic signal, determining the difference, and adjusting the value of porosity are repeated until the difference drops below a predetermined threshold or the difference reaches a minimum value. The adjusted value of porosity which results in the difference being at the minimum is taken as the formation porosity. A particular embodiment includes estimating conductivity of fluid in the pore spaces of the formation by calculating the synthetic seismoelectric voltages using an initial value of conductivity; determining a difference between the synthetic seismoelectric voltages and the measured seismoelectric voltages; and adjusting the initial value of conductivity, and repeating the steps of calculating the synthetic seismoelectric voltages, determining the difference and adjusting the value of conductivity until the difference reaches a minimum.

U.S. Pat. No. 4,639,675, issued to Hinton, discloses A conductivity anomaly detection system uses a rotating superconducting met to generate a known source field and an integrated detection system rotating with the superconducting magnet to detect anomalies in the generated source field caused by nearby conducting targets. The superconducting magnet is rigidly mounted in a Dewar which is in turn mounted on a shaft. An orthogonal detection system also is rigidly mounted on or within the Dewar with the superconducting magnet. The second harmonic of the anomaly signal from a target is detected for signal processing.

U.S. Pat. No. 5,041,792, issued to Thompson, discloses A low noise, magnetotelluric, intercalation electrode is disclosed that is both electronically and ionically conductive and stable in ground water brine. The electrode is comprised of an inert or chemically inactive long cylindrical and porous support shield, a semi permeable membrane located in the shield selectively permeable to the positive ions of a metal selected from the group consisting of Na+ and K+ ions, a brine electrolyte, and an electrode axis located in the brine electrolyte that includes an electronically conductive, metallic material ionically reversible to Na+ and K+. The electrode is sealed and attachable at its electrode axis to a wire leading to another electrode spaced apart therefrom. The wire connection permits voltage measurements and thereby provides a method for determining the resistivity between the electrodes at frequencies that are quite low without being interfered with by noise attendant prior art magnetotelluric electrodes. Thus, such electrodes allow meaningful resistivity measurements not previously obtainable.

U.S. Pat. No. 6,805,781, issued to S.o slashed.rensen et al., discloses The invention concerns an electrode device comprising an ion selective material, a solid state, inner reference system of sodium vanadium bronze and a contact material, where sodium may be reversibly intercalated, in the bronze. Such an electrode device may for instance be sensitive to ions, such as H.sup.+, Na.sup.+, K.sup.+ and Ca.sup.2+. It may also include a reactive material in which a particular analyte is reacted to form an ion product, to which the ion selective material is sensitive, such as in electrode devices of the Severinghaus-type or in biosensors. The electrode device according to the invention can be prepared by thick film printing.

The inventions heretofore known suffer from a number of disadvantages which include being limited in application, being limited in versatility, being limited in adaptability, failing to determine permeability of a fluid within a solid body, failing to observe characteristics of materials detected, failing to determine the identity of a detected fluid, requiring test wells to be drilled, and being expensive.

What is needed is a system for seismic detection and analysis that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems for seismic detection and analysis. Accordingly, the present invention has been developed to provide a system for detecting and processing electromagnetic signals from seismic activity.

In one embodiment, there is a system for detecting and processing electromagnetic signals from seismic activity, wherein the system may include an antenna configured to receive electromagnetic signals. The antenna may include a coiled electrical conduit having a length equal to about the diameter of the Earth. The antenna may also include a plurality of center taps disposed about critical resonant frequencies of a compound or element. The system may also include a signal processing module in communication with the antenna and configured to receive, and process, electromagnetic signals. The system may further include a impulse generation device configured to generate seismic activity. Furthermore, the system includes a control module in communication with the signal processing module and the impulse generation module and configured to provide instruction signals to each.

In another embodiment, there is a method of detecting the presence of materials in a substantially solid body, wherein the method may include the steps of generating a seismic impulse in a solid body. Then the method may include providing an antenna having an effective length equal to about the diameter of the solid body. The method may also include providing a center tap in the antenna, wherein the center tap may be disposed along the length of the antenna at a position associated with a resonant frequency of a particular material. The method may further include observing an electromagnetic return signal generated in the solid body in response to the seismic impulse. Then the method may include processing the electromagnetic return signal in correlation with timing of the seismic impulse, thereby forming processed signal information. In addition, the method may include isolating the resonant frequency from the electromagnetic return signal thereby forming isolated frequency information. Furthermore, the method may include displaying the isolated frequency information in association with the processed signal information in a manner that leads to understanding of a characteristic of a detected body of the particular material.

Reference throughout this specification to features, advantages, or similar language, does not imply that all of the features, and advantages, that may be realized with the present invention should be, or are, in any single embodiment of the invention. Rather, language referring to the features, and advantages, is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features, or advantages, of a particular embodiment. In other instances, additional features, and advantages, may be recognized in certain embodiments that may not be present in all embodiments of the invention.

These features, and advantages, of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention, briefly described above, will be rendered by reference to specific embodiments that are illustrated in the appended drawing(s). It is noted that the drawings of the invention are not to scale. The drawings are mere schematic representations, not intended to portray specific parameters of the invention. Understanding that these drawing(s) depict only typical embodiments of the invention and are not, therefore, to be considered to be limiting in its scope, the invention will be described and explained with additional specificity and detail through the use of the accompanying drawing(s), in which:

FIG. 1 is a side elevational view of an antenna of a system for detecting and processing electromagnetic signals from seismic activity, according to one embodiment of the invention;

FIG. 2 is a side elevational view of an antenna of a system for detecting and processing electromagnetic signals from seismic activity, according to one embodiment of the invention; and

FIG. 3 is a flow chart of a method of detecting the presence of materials, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like, described herein, are considered to be able to be combined in whole, or in part, one with another as the claims and/or art may direct, either directly or indirectly, implicitly or explicitly.

Many of the functional units described in this specification have been labeled as modules, in order to more particularly emphasize their implementation independence. For example, a module may be implemented as a hardware circuit comprising custom VLSI circuits, or gate arrays, off-the-shelf semiconductors, such as logic chips, transistors, or other discrete components. A module may also be implemented in programmable hardware devices, such as, field programmable gate arrays, programmable array logic, programmable logic devices, or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: antenna data; processed data; pre-weave data; post-weave data; and/or like data useful in the operation of the present invention. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines, or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware, and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, etc.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

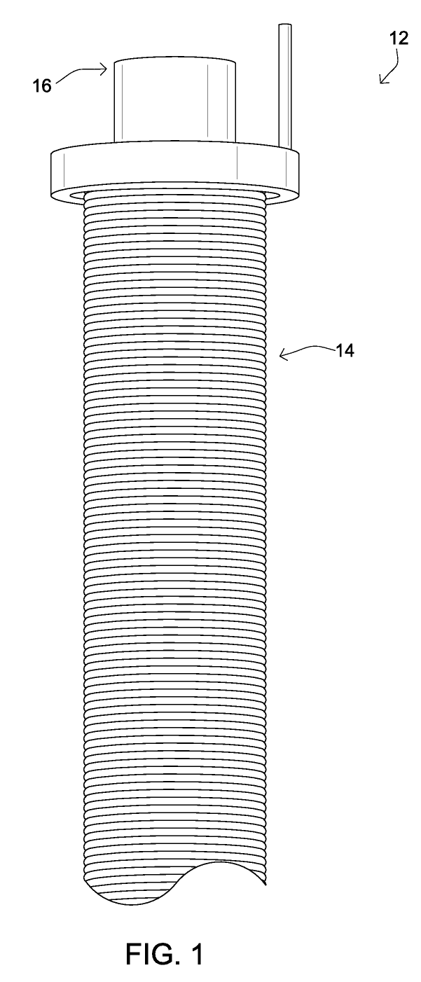

FIG. 1 illustrates an antenna 12 of a system and method of detecting the presence of materials in a substantially solid body, according to one embodiment of the invention, wherein the antenna 12 is configured to receive electromagnetic signals. As illustrated in FIG. 1, the antenna 12 includes a coiled electrical conduit 14 having a length equal to about the diameter of the Earth. In addition, the antenna 12 also includes the same wavelength as the Earth. The coiled electrical conduit 14 may be a coated copper wire, wherein one non-limiting example of a coated copper wire may be, but is not limited to, a Formvar coated copper wire. The antenna 12 further includes a core material 16, wherein the coiled electrical conduit 14 is wound around the core material 16. The core material 16 includes a ferromagnetic core material, wherein the ferromagnetic material enhances the magnetic field by producing magnetizations of magnitude greater than the applied field. Accordingly, the antenna 12 is configured to receive all frequencies relevant to wavelengths propagating within the Earth. In addition, the antenna 12 may be “tuned” to particular features and/or details of a planetoid, including but not limited to, particular structures and contents.

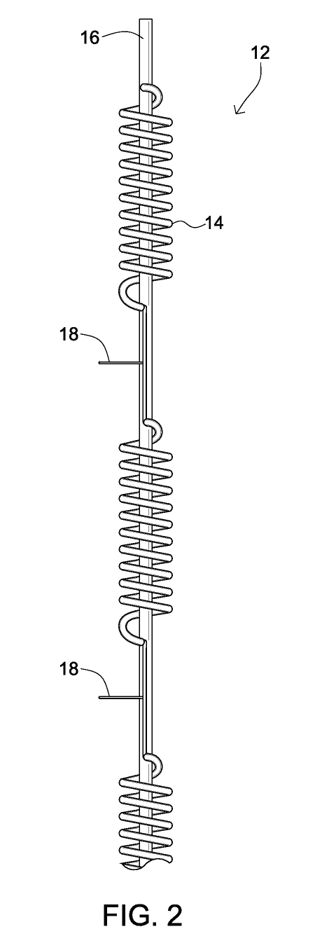

FIG. 2 illustrates an antenna 12 of a system and method of detecting the presence of materials in a substantially solid body, according to one embodiment of the invention, wherein the antenna 12 is multi-resonant and/or includes a plurality of center taps 18 disposed about critical resonant frequencies of a compound or element. Center taps 18 may be ohmic connections to portions of the antenna coil disposed at predetermined distances along the coil. The plurality of center taps 18 includes a center tap 18 disposed about the antenna 12, configured to detect one selected from the group consisting of: asphalt base oil, paraffin base oil, methane hydrate, coal-bed methane, minerals, elemental compounds, and organic compounds. Non-limiting examples of multi-resonant antennae are taught in U.S. Pat. Nos. 6,970,064; 7,242,364; and 4,571,596, which are incorporated for their supporting teachings herein.

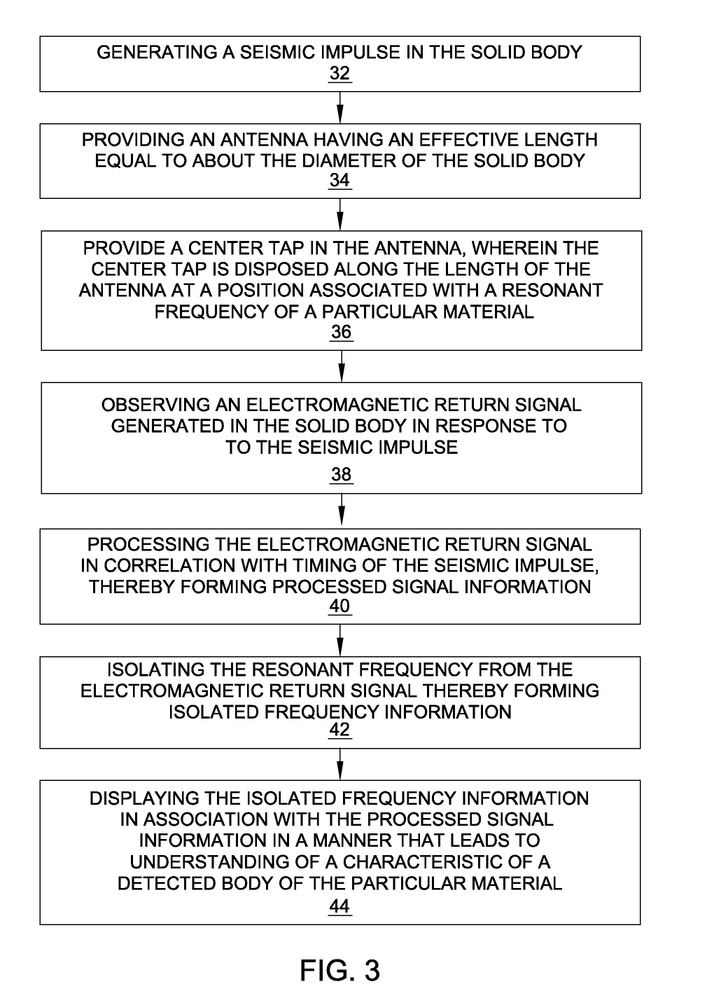

FIG. 3 illustrates a method of detecting the presence of materials in a substantially solid body, according to one embodiment of the invention, wherein the illustrated method includes the steps of: generating a seismic impulse in the solid body 32; providing an antenna having an effective length equal to about the diameter of the solid body 34; providing a center tap in the antenna associated with a resonant frequency of a particular material 36, observing an electromagnetic return signal generated in the solid body in response to the seismic pulse 38, processing the electromagnetic return signal in correlation with timing of the seismic impulse thereby forming processed signal information 40, isolating the resonant frequency from the electromagnetic return signal thereby forming isolated frequency information 42; and displaying the isolated frequency information in association with the processed signal information in a manner that leads to understanding of a characteristic of a detected body of the particular material 44.

It is understood that an embodiment of the invention may include one or more of the above listed steps, in whole or in part, and/or may specifically exclude one or more of the above listed steps, in whole or in part, and/or may exclude other non-listed steps that one skilled in the art may appreciate as sometimes, or always, being present in similar methods. Further, a system configured to carry out one or more of the steps of an embodiment of the invention may include one or more modules configured to carry out one or more of such steps. As a non-limiting example, there may be a signal processing module configured to process signal information.

A seismic impulse may be generated in a solid body (such as, but not limited to, the Earth) any number of ways, including, but not limited to, explosives, ground-pounding machines, high-powered rifles fired into the solid body, a method of excitement, a method of directed impulse, or a method of seismic wave generation, specifically a directed electromagnetic pulse. Further, such may be performed in arrays, time-series, a salvo, or in other manners as contemplated in the art. Accordingly, a seismic wave may be propagated through the solid body or a portion thereof.

There is also a step of providing an antenna having an effective length equal to about the diameter of the solid body. For example, in the context of imaging materials within the Earth, the effective length of the antenna may be about 12,756.1 km such that the antenna is configured to receive all frequencies relevant to waves propagating within the Earth. In one embodiment, an antenna includes a coil of conductive wire having an actual length of about one-half, one quarter, equal to, double, or a whole number, multiple or fraction, of the diameter of the Earth. The provided antenna may include features and/or structure as described in FIGS. 1 and/or 2. There may be a plurality of antenna that may be disposed in an array or known configuration and may be positioned to receive information generated in response to activity from one or more seismic sources.

The antenna may include one or more center taps or other structures configured to facilitate enhanced reception at a plurality of frequencies. The method further includes providing a center tap in the antenna, wherein the center tap is disposed along the length of the antenna at a position associated with a resonant frequency of a particular material. A center tap may include an ohmic connection disposed at a predetermined length of the antenna coil, such that, frequencies associated with such a length may be more easily observed.

There is also a step of observing an electromagnetic return signal generated in the solid body in response to the seismic impulse. This may be performed utilizing electronics to receive signal information from the antenna. One or more computers, signal processors, filters, and the like, may be employed as known in the art to observe an electromagnetic return signal generated in the solid body in response to the seismic impulse(s).

There is also processing the electromagnetic return signal in correlation with timing of the seismic impulse, thereby forming processed signal information. This may be accomplished by associating signal information with a particular seismic impulse and may be particularly important in the case of seismic salvo methods and/or 3-D imaging techniques. In one embodiment of the invention, a signal received from an antenna is converted according to a data conversion algorithm (weave) performed by a data conversion module, and then a post-weave step is performed on the date by a post-weave module. In a non-limiting example, a data conversion algorithm may include the steps of generating a function according to variably weighted data values.

There is also a step of isolating the resonant frequency from the electromagnetic return signal thereby forming isolated frequency information. Such may be accomplished directly through one or more center taps. Such information may be added mathematically, or in an analog manner, to other signal information received such that signal information, or processed signal information, may be augmented to more particularly focus on one or more particular materials, or characteristics, of the solid body. Augmented information may be processed as described in this application.

There is also a step of displaying isolated frequency information in association with the processed signal information in a manner that leads to understanding of a characteristic of a detected body of the particular material. In another embodiment, Augmented signal information may instead, or together, be so displayed. This may be accomplished using graphical display means, such as, but not limited to, colored signal graphs and charts as known in the art wherein lines, colors, intensities, and the like, are associated with portions of information within signal information, processed signal information, isolated signal information, and/or augmented signal information, such that one skilled may be able to deduce a characteristic of the solid body or a portion thereof, such as, but not limited to, finding regions of oil having characteristics associated with profitable wells.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the system and method describe generating a seismic impulse in the solid body, one skilled in the art would appreciate that the seismic impulse may be generated by any type of seismic impulse known to one skilled in the art.

Additionally, although the figures illustrate an exemplary antenna, one skilled in the art would appreciate that the antenna may vary in size, length, width, height, configuration, material, coating, strength, design, color, and still perform its intended function.

Finally, it is envisioned that the components of the device may be constructed of a variety of materials, metal, metal alloys, rubber, rubber composite, glass, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use, may be made without departing from the principles and concepts of the invention as set forth in the claims. Further, it is contemplated that an embodiment may be limited to consist of, or to consist essentially of, one or more of the features, functions, structures, and methods described herein.

What is claimed is:

1. A system for detecting and processing electromagnetic signals from seismic activity in the Earth, comprising:
a) an antenna configured to receive electromagnetic signals; wherein the antenna includes:
i) a coiled electrical conduit having a length equal to about the diameter of the Earth, and
ii) a plurality of center taps disposed about critical resonant frequencies of a compound or element;
b) a signal processing module in communication with the antenna and configured to receive and process electromagnetic signals;
c) a impulse generation device configured to generate seismic activity; and
d) a control module in communication with the signal processing module and the impulse generation module and configured to provide instruction signals to each.

2. The system in claim 1, wherein the plurality of center taps includes a center tap disposed about the antenna, configured to detect one selected from the group consisting of: asphalt base oil, paraffin base oil, methane hydrate, coal-bed methane, minerals, elemental compounds, and organic compounds.

3. The system of claim 1, wherein the antenna further includes a core material, wherein the coiled electrical conduit is wound around the core material.

4. The system of claim 3, wherein the core material further includes a ferromagnetic core material.

5. The system of claim 1, wherein the signal processing module further includes a display module configured to display 3-Dimensional or 4-Dimensional output from the electromagnetic signals.

6. A system for detecting and processing electromagnetic signals from seismic activity in a solid body, comprising:
a) an antenna configured to receive electromagnetic signals; wherein the antenna includes:
i) a coiled electrical conduit having an effective length equal to about the diameter of the solid body, wherein the coiled electrical conduit includes a layer of dielectric material disposed between each coil layer,
ii) a solid core covered in a dielectric material; and
ii) a plurality of center taps disposed about critical resonant frequencies of a predetermined material;
b) a signal processing module in communication with the antenna and configured to receive and process electromagnetic signals;
c) a impulse generation device configured to generate seismic activity; and
d) a control module in communication with the signal processing module and the impulse generation module and configured to provide instruction signals to each.

7. The system of claim 6, wherein the center taps are positioned to be associated with resonant frequencies of materials associated with underground energy reserves.

8. The system of claim 6, wherein the signal processing module includes a weave module and a post-weave module configured to process signal data from the antenna.

9. The system of claim 8, wherein the post-weave module performs a FOURIER TRANSFORM operation.

10. The system of claim 6, wherein the coiled electrical conduit has an actual length equal to about a whole number fraction of the diameter of the associated solid body and wherein the whole number is less than five.

11. The system of claim 6, wherein the coiled electrical conduit has an actual length equal to about a whole number multiple of the diameter of the associated solid body and wherein the whole number is less than five and greater than or equal to one.

12. A method of detecting the presence of materials in a substantially solid body, comprising the steps of:
a) generating a seismic impulse in the solid body;
b) providing a multi-resonant antenna having an effective length equal to about the diameter of the solid body;
d) observing an electromagnetic return signal generated in the solid body in response to the seismic impulse; and
e) processing the electromagnetic return signal in correlation with timing of the seismic impulse, thereby forming processed signal information.

13. the method of claim 12, further comprising the steps of:
f) isolating the resonant frequency from the electromagnetic return signal thereby forming isolated frequency information; and
g) displaying the isolated frequency information in association with the processed signal information in a manner that leads to understanding of a characteristic of a detected body of the particular material.

14. The method of claim 12, wherein the plurality of center taps includes a center tap disposed about the antenna, configured to detect one selected from the group consisting of: asphalt base oil, paraffin base oil, methane hydrate, coal-bed methane, minerals, elemental compounds, and organic compounds.

15. The method of claim 12, wherein the antenna further includes a core material covered in dielectric material, wherein the coiled electrical conduit is wound around the core material and alternating layers of dielectric material and disposed therebetween.

16. The method of claim 12, wherein the multi-resonant antenna includes a center tap in the antenna, wherein the center tap is disposed along the length of the antenna at a position associated with a resonant frequency of a particular material;

17. The method of claim 15, wherein the core material further includes a ferromagnetic core material.

18. The method of claim 12, further comprising providing seismic input, detection capabilities, and processing modules configured to provide 3-Dimensional information.

19. The method of claim 12, wherein the step of processing includes a weave step and a post-weave step, wherein in the weave step signal data is weighted according to an algorithm.

20. The method of claim 19, wherein the post-weave steps includes performing a FOURIER TRANSFORM operation.
